(19) United States
(12) Patent Application Publication
(10) Pub. No.: US 2017/0156158 A1
(43) Pub. Date: Jun. 1, 2017

(54) METHOD AND APPARATUS FOR UTILIZING COMMUNICATION CONFIGURATION PREFERENCES

(71) Applicant: NOKIA SOLUTIONS AND NETWORKS OY, Espoo (FI)

(72) Inventor: John HARRIS, Glenview, IL (US)

(21) Appl. No.: 14/954,119

(22) Filed: Nov. 30, 2015

(51) Int. Cl. H04W 72/12; H04W 52/02

(52) U.S. Cl. CPC H04W 72/1284; H04W 72/1231; H04W 52/0216

(57) ABSTRACT

Systems, methods, apparatuses, and computer program products relating to communication configuration preferences are provided. One method includes a user equipment causing the transmission to a network node an indication of a preferred network configuration. The method may also include causing the transmission of an indication of a preference for at least one condition when the indicated preference of the preferred network configuration should expire or resume.

### BACKGROUND

Field

Embodiments of the invention generally relate to wireless or mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), future 5G radio access technology, and/or High Speed Packet Access (HSPA). For example, some embodiments may relate to user equipment (UE) preferences for a communication configuration.

Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided in the enhanced Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN provides a new radio access technology and refers to the improvements of UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while keeping the backward compatibility.

### SUMMARY

One embodiment is directed to a method, which may include causing, by a user equipment, a transmission to a network node of an indication of a preferred network configuration. The method may also include causing a transmission of an indication of a preference for at least one condition when the indicated preference of the preferred network configuration should at least one of expire or resume.

Another embodiment is directed to an apparatus that may include at least one processor, and at least one memory comprising computer program code. The at least one memory and the computer program code are configured, with the at least one processor, to cause the apparatus at least to transmit to a network node an indication of a preferred network configuration, and transmit an indication of a preference for at least one condition when the indicated preference of the preferred network configuration should at least one of expire or resume.

Another embodiment is directed to a computer program, embodied on a non-transitory computer readable medium. The computer program is configured to control a processor to perform a process that may include causing, by a user equipment, a transmission to a network node of an indication of a preferred network configuration. The process may also include causing a transmission of an indication of a preference for at least one condition when the indicated preference of the preferred network configuration should at least one of expire or resume.

Another embodiment is directed to an apparatus that may include transmitting means for causing a transmission to a network node of an indication of a preferred network configuration. The apparatus may also include transmitting means for causing a transmission of an indication of a preference for at least one condition when the indicated preference of the preferred network configuration should at least one of expire or resume.

Another embodiment is directed to a method, which may include causing the receiving, from a user equipment, of an indication of a preferred network configuration of the user equipment. The method may also include the causing of the receiving of an indication of a preference for at least one condition when the indicated preferred network configuration should expire and/or resume. When the at least one condition is fulfilled, the indicated preferred network configuration expires or resumes.

Another embodiment is directed to an apparatus that may include at least one processor, and at least one memory comprising computer program code. The at least one memory and the computer program code are configured, with the at least one processor, to cause the apparatus at least to receive, from a user equipment, an indication of a preferred network configuration of the user equipment, to receive an indication of a preference for at least one condition when the indicated preferred network configuration should expire and/or resume. When the at least one condition is fulfilled, the indicated preferred network configuration expires or resumes.

Another embodiment is directed to a computer program, embodied on a non-transitory computer readable medium. The computer program is configured to control a processor to perform a process that may include causing the receiving, from a user equipment, of an indication of a preferred network configuration of the user equipment. The process may also include the causing of the receiving of an indication of a preference for at least one condition when the indicated preferred network configuration should expire and/or resume. When the at least one condition is fulfilled, the indicated preferred network configuration expires or resumes.

Another embodiment is directed to an apparatus that may include receiving means for causing the receiving, from a user equipment, of an indication of a preferred network configuration of the user equipment. The apparatus may also include receiving means for causing the receiving of an indication of a preference for at least one condition when the indicated preferred network configuration should expire and/or resume. When the at least one condition is fulfilled, the indicated preferred network configuration expires or resumes.

### BRIEF DESCRIPTION OF THE DRAWINGS

For proper understanding of the invention, reference should be made to the accompanying drawings, wherein:

FIG. 1 illustrates an example signaling diagram, according to an embodiment;

FIG. 2 illustrates an example signaling diagram, according to another embodiment;

FIG. 3 illustrates an example of a UE preference indication, according to an embodiment;

FIG. 4 illustrates an example signaling diagram, according to another embodiment;

FIG. 5 illustrates an example of a UE preference indication, according to another embodiment;

FIG. 6 illustrates an example signaling diagram, according to another embodiment;

FIG. 7 illustrates an example of a UE preference indication, according to another embodiment;

FIG. 8a illustrates an example block diagram of an apparatus, according to one embodiment;

FIG. 8b illustrates an example block diagram of an apparatus, according to another embodiment;

FIG. 9a illustrates an example flow diagram of a method, according to an embodiment;

FIG. 9b illustrates an example flow diagram of a method, according to another embodiment;

FIG. 10a illustrates an example block diagram of an apparatus, according to one embodiment; and

FIG. 10b illustrates an example block diagram of an apparatus, according to another embodiment.

### DETAILED DESCRIPTION

It should be understood that the components of the invention, as generally described and illustrated in the figures herein, may be arranged and designed in a wide variety of different configurations. Thus, the following detailed description of embodiments of systems, methods, apparatuses, and computer program products for automatically transitioning between utilizing and not utilizing a UE preference for a communication configuration, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Some embodiments generally address the creation of an extended protocol, which may be referred to as a knowledge sharing protocol, where the application is interacting with specific radio signaling or messaging in order to create various value propositions for both the UE manufacturer/application and the network/network provider. This protocol extension may be proprietary or may be standardized. An embodiment is directed to enabling automatically the transitioning between the utilizing and not utilizing a UE indicated preference for a communication configuration.

A UE can utilize messaging to request that the network consider making a number of specific changes to the UE network configurations. However, benefits are possible with a mechanism for the UE to indicate in which cases the UE wishes that change to be persistently or non-persistently used. For example it was not possible for the UE to indicate, at the time of the preference request, the conditions upon which that request should be expire (and possibly then resume). For example, greater clarity in this area may improve performance, avoiding inefficient network configurations, and additional messaging and/or delays. In other words, some embodiments may address a range of scenarios where the UE request (or requested value) should automatically revert to the normal value/network determined default.

In UMTS, the UE had the ability to explicitly and directly release the channel so the UE would cause resources to be released and would go into a state resembling idle. However, this caused numerous problems as, for example, the UE would, in many cases, go into a state resembling idle and then immediately initiate returning to a more connected state.

With LTE, the UE does not have the ability to control whether to go idle or not. Instead, the entire capability of deciding whether the UE would go idle was limited to the eNB.

However, according to an embodiment, the UE may have the ability to indicate its “preference” that it go to idle, where the UE is still not making the decision per se to go to idle, as the final decision is with the network node (e.g., eNB). In some embodiments, the eNB may receive additional guidance from the UE, helping the eNB to better decide how to utilize the UE preference. For example, the eNB may be able to use guidance on identifying what would be the future conditions in which the UE would prefer that the eNB discards the UE requested inactivity timer and returns the UE to an eNB determined default timer.

Many UE services require rebuilding the RRC connection, within “tens” of seconds after it is torn down (using conventional RRC inactivity timers). The UE may be able to use its knowledge to identify (these) “predictable” services, which are done utilizing the channel for “tens” of seconds, but which “will” use the channel again in some “tens” of seconds from later.

In one example, “predictable” services may result in additional signaling (when re-connecting) and higher battery life drain and channel maintenance signaling (during the long “tail”/while idling on channel). In this example, wireless services may result in a significant fraction of the battery life drain occurring during the tail, e.g., while the UE is idling on the channel with its modem on.

Motivations for utilizing RRC connected discontinuous reception (DRX) for these “predictable” services may include avoiding one or both of: a) using a shorter inactivity timer where low battery drain and less channel maintenance signaling may occur but where additional signaling may also result (e.g., RRC)—; b) using a longer inactivity timer resulting in a longer RRC connection time which may yield low signaling (e.g., RRC)—but also results in high battery drain and additional channel maintenance (CQI) signaling. In contrast, by using connected DRX, and an extension to the RRC inactivity timer the solution may avoid extra signaling (e.g., RRC)—while also lowering battery drain and channel maintenance signaling. By lowering the (RRC) signaling rate, the UE may gain operator preference and/or help improve network performance. By lowering the battery drain (and channel maintenance signaling) rate, the UE may also gain subscriber preference.

In some embodiments, a UE can utilize additional messaging. The messaging may comprise, for example: a request to immediately immediate transition to idle, e.g., quick idle, a request for an extension to the RRC connection inactivity time, a request to utilize an application suggested connected DRX value, or a request to receive a network estimate of the current network congestion.

With respect to the quick idle request, a high level user story is that the UE will transmit this when it wishes to go (more) immediately to idle. In order to contextualize the quick idle problem, consider the following scenario. In this scenario, the UE transmits the request to go idle. At almost the same time, or subsequently prior to the completion of the current transfer, a new application begins. In this case, it may be preferable that the quick idle request “expires”. For example, the UE may transmit this quick idle request some interval prior to the end of the currently in progress download. This can for example enable the UE to save resources by “piggybacking” this request with other data traffic on the uplink, shortly before that “last” transfer completes. The UE vendor/solution may do this with the intention that, after the download completes, the UE will immediately transition to idle.

In this case, an approach may be applied to address the scenario where new application traffic or information becomes available to the application/UE OS after the quick idle request is generated, but before the UE transitions to idle. In the event that the network receives such a quick idle request, an embodiment may efficiently manage the determination of when to (autonomously) return to a normal default RRC inactivity timer.

According to an embodiment, the quick idle problem may be addressed by supporting explicit signaling on the part of the UE. For example, the UE quick idle request may indicate the expiration time/policy of the quick idle request. This may be such that the quick idle request is canceled if more than a threshold amount of additional data flow (and/or time) elapses after the quick idle request, (and yet the UE is not/has not been transitioned to idle because data traffic is still flowing). In another example, the UE request may also indicate that the quick idle request should immediately expire if new traffic on a new logical channel identifier (LC ID)/flow arrives.

In an alternate embodiment, a first message may indicate the persistency that should be associated with the quick idle requests. Subsequently, when the UE wishes to quickly transition to idle, it can then request such a transition, and the eNB will automatically associate the previously configured persistency with this most recent request to quickly transition to idle.

An extension to the RRC inactivity time may be used, for example, if the UE, application, and/or operating system (OS) has knowledge/expects that that additional data activity is going to occur, for example 15 to 20 seconds in the future after an interval of inactivity, such that transitioning to idle for only five seconds is not preferred/efficient. The problem is that the network does not know whether the UE or OS prefers/is requesting that the extension to the RRC inactivity time request is a persistent request or a more limited, e.g., one time, request. It should be noted that the OS may be a component of the UE, or, alternatively, may be a separate application that may be run on the UE.

As an example, the application or OS may determine that additional data activity is likely to occur after some prolonged interval of inactivity, such that the UE would prefer to stay in the connected state. The UE transmits the request to extend the RRC connection inactivity timer during this immediate interval.

In another scenario, it may be that the application or OS knows that the application pattern is such that this ˜15 second interval of inactivity will continue to repeatedly occur after each subsequent transfer. This may be the case for example in certain streaming applications, e.g., where the application typically downloads ˜some tens of seconds of media, and then there is no activity until the buffer starts to become low. In this case, the UE and/or OS may prefer to utilize a “persistent” request for an extension to the RRC inactivity time, e.g., with a persistent change to lengthen the RRC inactivity timer. However, at some later point the application may become aware that this application has stopped, such that it is appropriate to return to a normal RRC inactivity timer. In other words, subsequently the application or OS (within the same RRC connected interval) may determine that the application or OS situation has changed, and it no longer expects additional data activity after some prolonged interval of inactivity, e.g., 30 seconds.

According to an embodiment, a possible solution providing improved functionality associated with requesting an extension to the RRC inactivity time may include supporting explicit signaling on the part of the UE supporting at least one of the following. The UE request to extend the RRC inactivity timer indicates the request for an extension to the RRC inactivity timer will expire according to at least one of the following: a) the request is canceled if more than a threshold amount of additional data continues to flow (and/or time elapses), b) this request expires after its first “use,” c) this request expires after the UE goes out of sync “n” times, and/or d) the traffic on an associated LCID/flow/LCG is no longer present, e.g., where the UE previously indicated that the request is associated with a particular LC ID. Optionally, the UE may initiate a message to cancel the original request for an RRC inactivity timer extension, e.g., requesting that the UE returned to a default inactivity timer value.

In some embodiments, the UE may request alternate connected DRX settings. For example, consider the scenario where the application/OS determines that low latency downlink data is unlikely to be present, such that the UE would prefer that the long DRX configuration have a particular value. The UE may transmit a request for the use of a particular set of connected DRX values. However, it may be that in some cases the UE will wish to have this request be in place only for a short time interval, e.g., including the next time interval where the UE goes out of sync, but not including the subsequent time interval after the UE returns from being out of sync. Alternatively, it may be that the application has a long-term periodic structure, e.g., as may be the case with streaming music. In this case, it may be that the UE would prefer to continue to utilize the suggested connected DRX value for the rest of that RRC connection (unless there is some explicit signaling to the contrary from the UE).

According to an embodiment, this problem may be addressed by supporting explicit signaling on the part of the UE supporting at least one of the following. The UE may indicate its request for an extension to the RRC inactivity timer, while further indicating conditions upon which the request for the UE suggested connected DRX configuration should expire. For example, this UE initiated messaging may indicate that the requested setting should expire after at least one of: a) after the UE becomes goes out of sync “n” times, b) if more than a threshold amount of time lapses after the UE connected DRX request, and/or c) traffic on a new LC ID/flow arrives.

Thus, certain embodiments may address a range of scenarios where the UE request (or requested value) should revert to the normal value/network determined default. One example embodiment is that this may be based upon the arrival or disappearance of different types of traffic. For example, if a new type of data traffic on a new LC ID or flow arrives, that may mean that there is a new application which may not fit with the previous request for a longer inactivity timer, such that the inactivity timer should (implicitly) return to the default value.

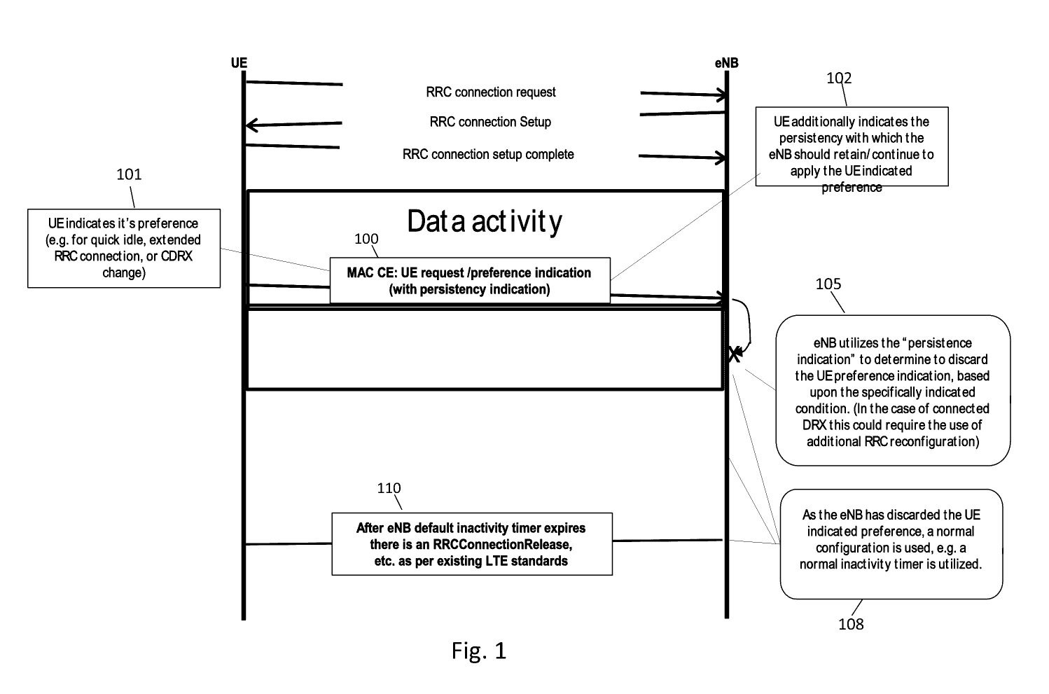

FIG. 1 illustrates an example signaling diagram between a UE and base station/access node (e.g., eNB), according to one embodiment. As illustrated in the example of FIG. 1, after the RRC connection setup is completed, the UE may indicate at 100 (e.g., in a MAC CE) its preference, such as for a short inactivity timer/quick transition to idle, an extension to the RRC inactivity timer, and/or RRC connected discontinuous reception change, as depicted in 101. As depicted in 102, the UE may additionally indicate the persistency with which the eNB should retain/continue to apply the UE indicated preference. At 105, the eNB may then utilize the persistence indication to determine when to discard the UE preference indication, based upon the specifically indicated condition. In the case of connected DRX, this may involve the use of an additional RRC reconfiguration. After the eNB has discarded the UE indicated preference, at 108, a normal configuration may be used, e.g., a normal inactivity timer is utilized. Therefore, at 110, after the eNB default inactivity timer expires there may be an RRCConnectionRelease, according to existing LTE standards.

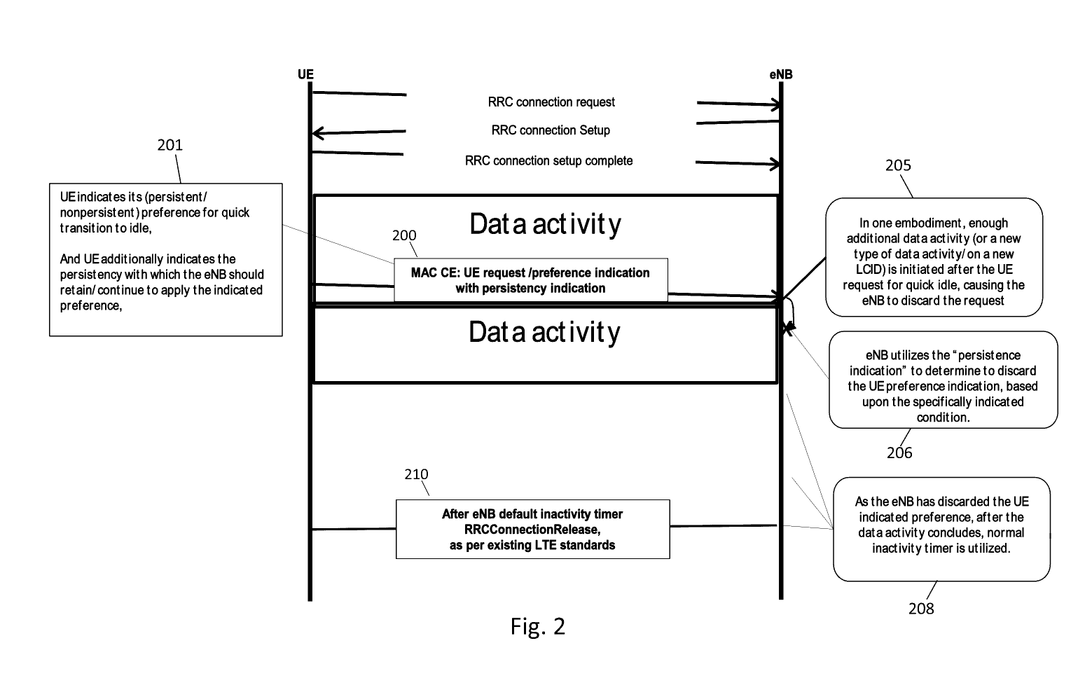

FIG. 2 illustrates an example signaling diagram between a UE and base station/access node (e.g., eNB), according to another embodiment. FIG. 2 illustrates an example where the UE indicated preference is to transition to idle and where the preference has certain conditions or persistency. As illustrated in FIG. 2, at 200, the UE may indicate its (persistent/nonpersistent) preference for quick idle, and the UE may additionally indicate the persistency with which the eNB should retain/continue to apply the indicated preference, as depicted at 201. For example, the UE may indicate if the eNB should automatically discard the request if either: a) it cannot be fulfilled (during inactivity) within some specific time interval, or b) a new LCID or traffic type arrives before the UE dormancy request can be fulfilled (i.e., the UE goes idle). In one embodiment, at 205, enough additional data activity (or a new type of data activity/on a new LCID) may be initiated after the UE request for a quick transition to idle, causing the eNB to discard the request. At 206, the eNB may utilize the “persistence indication” to determine to discard the UE preference indication, based upon the specifically indicated condition. As the eNB has discarded the UE indicated preference, at 208, after the data activity concludes, normal inactivity timer is utilized. Therefore, at 210, after the eNB default inactivity timer expires there may be an RRCConnectionRelease, according to existing LTE standards.

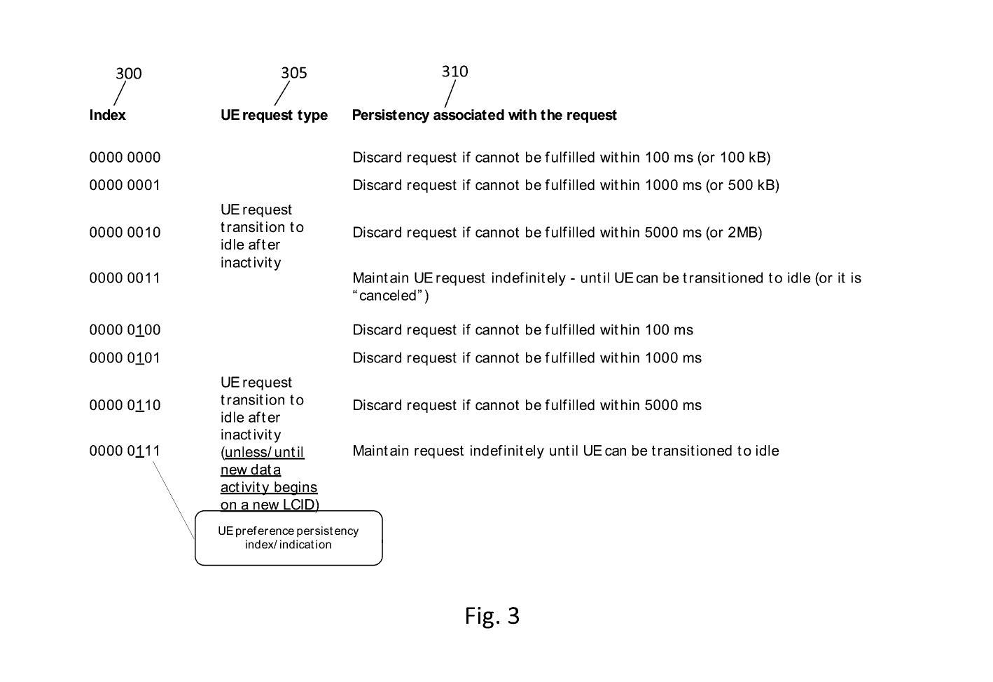

FIG. 3 illustrates an example of UE request types where the UE indicated preference additionally indicates persistency/condition. As illustrated in the example of FIG. 3, the UE request may include a UE preference persistency index/indication 300. In this example, the UE request type 305 may be that the UE requests transition to idle after inactivity, or the UE requests transition to idle after inactivity until new data activity begins on a new LCID. In addition, each of the request types may have various persistencies associated with the request 310. For example, the persistency may indicate that the request should be discarded if it cannot be fulfilled within a certain time period.

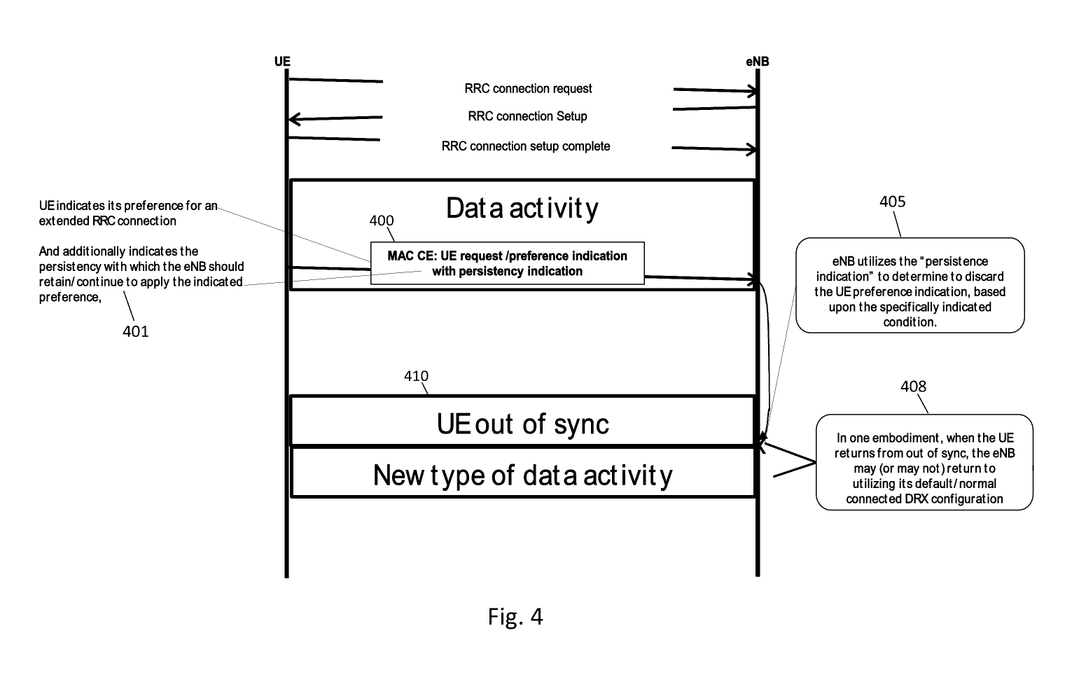

FIG. 4 illustrates an example signaling diagram between a UE and base station/access node (e.g., eNB), according to another embodiment. FIG. 4 illustrates an example where the UE indicated preference is to extend the RRC connection and where the preference has certain conditions or persistency. As illustrated in FIG. 4, at 400, the UE may indicate its preference for an extended RRC connection, and may additionally indicate the persistency with which the eNB should retain/continue to apply the indicated preference, as depicted at 401. For example, the UE may indicate if the eNB should automatically discard the request when the UE has gone out of sync and has now returned to in sync. At 405, the eNB may utilize the “persistence indication” to determine to discard the UE preference indication, based upon the specifically indicated condition. In one embodiment, at 410, when the UE returns from out of sync, the eNB may (or may not) return to utilizing its default/normal connected DRX configuration, as depicted at 408.

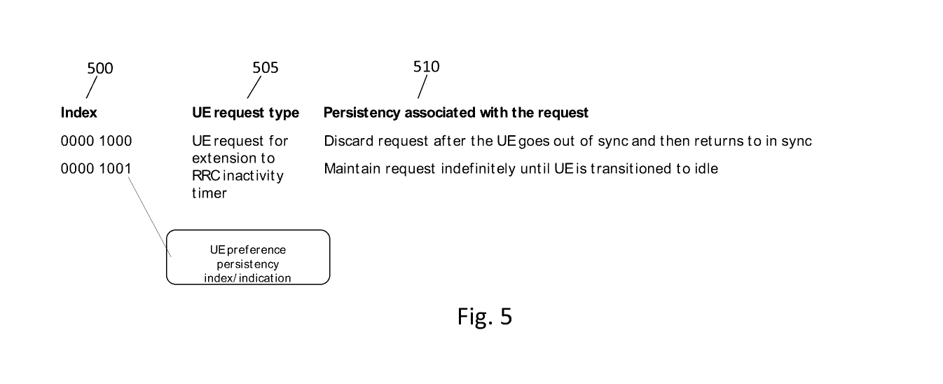

FIG. 5 illustrates an example of a UE request type where the UE indicated preference additionally indicates persistency/condition. As illustrated in the example of FIG. 5, the UE request may include a UE preference persistency index/indication 500. In this example, the UE request type 505 may be that the UE requests for extended RRC connection. In addition, the request type may have various persistencies associated with the request 510. For example, the persistency may indicate that the request should be discarded after the UE goes out of sync and then returns to in sync, or may indicate that the request should be maintained indefinitely until the UE is transitioned to idle.

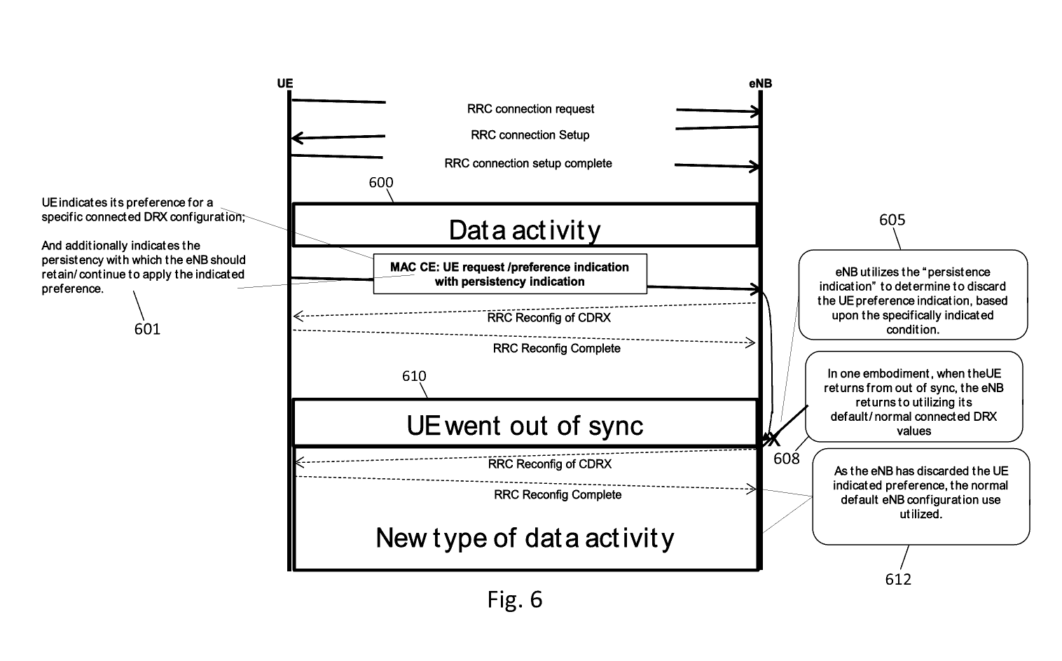

FIG. 6 illustrates an example signaling diagram between a UE and base station/access node (e.g., eNB), according to another embodiment. FIG. 6 illustrates an example where the UE indicated preference for different connected DRX configuration and where the preference has certain conditions or persistency. In this example, at 600, the UE may indicate its preference for a specific connected DRX configuration, and may additionally indicate the persistency with which the eNB should retain/continue to apply the indicated preference, as depicted at 601. For example, the UE may indicate if the eNB should automatically discard the request when either: a) the UE has gone out of sync (and has now returned to in sync), or b) a specific LCID traffic type has arrived, for instance where that new traffic type could have different or stricter downlink delay requirements such that the default C-DRX configuration may be more appropriate. At 605, the eNB may utilize the “persistence indication” to determine to discard the UE preference indication, based upon the specifically indicated condition. In one embodiment, at 610, when the UE returns from out of sync, the eNB returns to utilizing its default/normal connected DRX values, as depicted at 608. As the eNB has discarded the UE indicated preference, the normal default eNB configuration may be utilized, as depicted at 612.

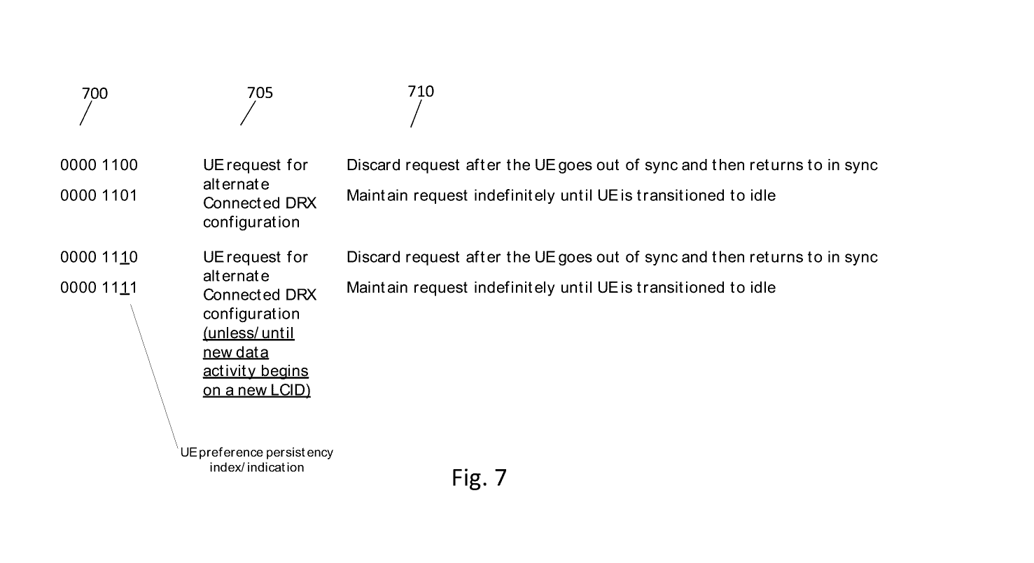

FIG. 7 illustrates an example of a UE request type where the UE indicated preference additionally indicates persistency/condition. As illustrated in the example of FIG. 7, the UE request may include a UE preference persistency index/indication 700. In this example, the UE request type 705 may be that the UE requests for alternate connected DRX configuration, or that the UE requests for alternate connected DRX configuration until new data activity begins on a new LCID. In addition, the request type may have various persistencies associated with the request 710. For example, the persistency may indicate that the request should be discarded after the UE goes out of sync and then returns to in sync, or may indicate that the request should be maintained indefinitely until the UE is transitioned to idle.

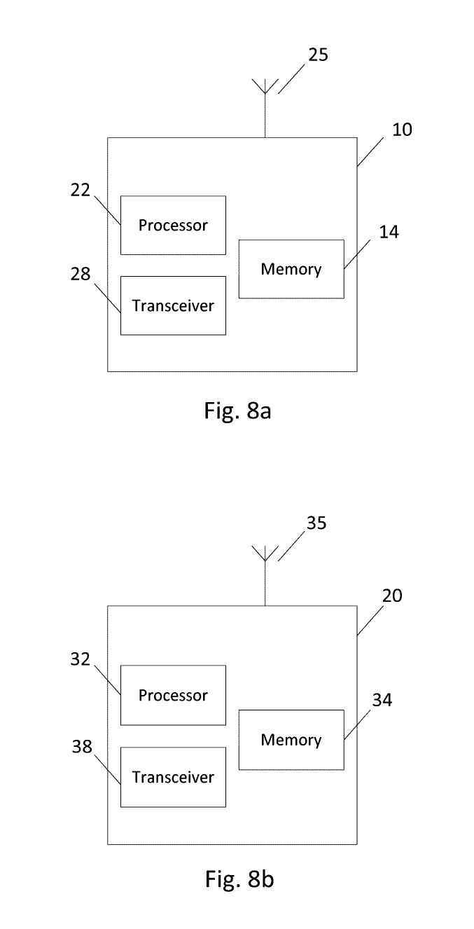

FIG. 8a illustrates an example of an apparatus 10 according to an embodiment. In an embodiment, apparatus 10 may be a node, host, or server in a communications network or serving such a network. For example, in certain embodiments, apparatus 10 may be a network node or access node for a radio access network, such as a base station e.g., NodeB (NB) in UMTS or eNodeB (eNB) in LTE or LTE-A. However, in other embodiments, apparatus 10 may be other components within a radio access network. It should be noted that one of ordinary skill in the art would understand that apparatus 10 may include components or features not shown in FIG. 8a.

As illustrated in FIG. 8a, apparatus 10 includes a processor 22 for processing information and executing instructions or operations. Processor 22 may be any type of general or specific purpose processor. While a single processor 22 is shown in FIG. 5a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be a network node or access node, such as a base station in UMTS or an eNB in LTE or LTE-A, for example. According to certain embodiments, apparatus 10 may be controlled by at least one memory 14 and at least one processor 22 to receive, from a UE, an indication of a preferred network configuration of the UE. Apparatus 10 may be controlled by at least one memory 14 and at least one processor 22 to further receive an indication of a preference for one or more conditions when the UE indicated preferred network configuration should automatically expire and/or resume. For example, the condition(s) may indicate at which point the UE prefers that the network stops using the parameter value previously preferred/indicated by the UE. In an embodiment, when the condition(s) is fulfilled, the indicated preferred network configuration may expire and/or resume.

According to one embodiment, the UE indicated network configuration may include a quick idle request, a request to extend RRC connection or inactivity timer value, a request for an updated connected DRX configuration, and/or a request for recurring series of congestion indications be provided to the UE.

In an embodiment, the UE indication of the preference for the one or more conditions may include an indication of at least one of the following. For example, the indication may convey that the UE request should preferably expire after a first time interval, e.g., where the UE is still RRC connected. For example, the request may indicate that the quick idle transition request is canceled if more than a threshold amount of additional data has continued to flow (and/or time lapses) after the quick idle request, (and yet the UE has not yet been transitioned to idle because the data is still flowing). In another example, the UE request may expire after at least a threshold number of additional bytes are transferred (e.g., while the UE is still RRC connected). In another example, the UE request may expire after a new traffic LCID/flow begins, e.g., according to the stated criteria defining such an event. For example, the request may indicate that the quick idle request may immediately expire if new traffic on a new LC ID/flow arrives.

In another example, the UE request may indicate that the UE request should expire after a previously existing traffic LCID/flow stops (e.g., according to some further criteria defining “stops”). In one example, the traffic on an associated LCID/flow/LCG is no longer present, e.g., where the UE previously indicated that the extended RRC connection request is associated with a particular LC ID. The UE request may expire after the UE preference is practiced or fulfilled a threshold number of times. For example, in the case of the RRC connection extension request, if the default inactivity timer is 10 seconds, and the UE requests that the RRC connection be extended up to 30 seconds of inactivity, then each time there is more than 10 seconds of inactivity, the extended RRC connection request is considered to have been “utilized.” In another example, if the preference is for a preferred value of parameters associated with long DRX, then each time the UE enters DRX and then leaves DRX, the UE preference is considered to have been utilized one additional time. The UE request may indicate that the request should expire after the UE goes out of sync a threshold number of times. The UE request may indicate that the UE request should expire after the UE enters idle more than a threshold number of times. An indication may further indicate the UE preference request should resume if a particular LC ID resumes, (or after one of the other policies described).

According to an embodiment, apparatus 10 may be controlled by one or more memory 14 and one or more processor 22 to receive a request for a recurring series of congestion indications from the UE, and to provide a recurring series of congestion indications down to the UE. At least one of the indications may include policies that control at what point the apparatus 10 can presume that the UE no longer prefers that the network provide such updates. In one embodiment, the UE congestion update request may serve to cause a series of congestion updates be provided at a first rate during a first time interval, and then be provided at a second rate at a second time interval. The congestion update request may cause the rate of updates to be linked to the current DRX setting, where congestion updates do not reset the short/long DRX state, and the congestion updates are provided more frequently during short DRX and less frequently during the long DRX.

Furthermore, apparatus 10 may be controlled by one or more memory 14 and one or more processor 22 to receive, from a UE, a range of policies that further indicate specific conditions which will result in the periodicity of the recurring updates changing. For instance, the congestion updates should be provided periodically at a first rate, until a particular LC ID stops, after which they should be provided at a second rate. In an embodiment, the congestion updates should be provided periodically at a first rate, until a particular (new) LC ID starts, after which they should be provided at a second rate.

FIG. 8b illustrates an example of an apparatus 20 according to another embodiment. In an embodiment, apparatus 20 may be a node or element in a communications network or associated with such a network, such as a UE, mobile device, mobile unit, machine type UE or other device. For instance, in some embodiments, apparatus 20 may be UE in LTE or LTE-A. It should be noted that one of ordinary skill in the art would understand that apparatus 20 may include components or features not shown in FIG. 8b.

As illustrated in FIG. 8b, apparatus 20 includes a processor 32 for processing information and executing instructions or operations. Processor 32 may be any type of general or specific purpose processor. While a single processor 32 is shown in FIG. 8b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a mobile device, such as a UE in LTE or LTE-A. In one embodiment, apparatus 20 may be controlled by at least one memory 34 and at least one processor 32 to transmit to a network node (e.g., eNB) an indication of a preferred network configuration. Apparatus 20 may be controlled by at least one memory 34 and at least one processor 32 to further transmit an indication of a preference for one or more conditions when the indicated preference should expire or resume.

In one embodiment, the indication of the preferred network configuration may include a quick idle request, a request to extend a radio resource control (RRC) connection or inactivity timer value, a request for an updated connected discontinuous reception (DRX) configuration, and/or a request for recurring series of congestion indications to the apparatus.

According to an embodiment, the indication of the preference for the condition(s) includes at least one of: a request should preferably expire after a first time interval, the request should expire after at least a threshold number of additional bytes are transferred, the request should expire after a new traffic logical channel identifier (LCID)/flow begins, the request should expire after a previously existing traffic LCID/flow stops, the request should expire after the preference is “utilized” or fulfilled a threshold number of times, the request should expire after the apparatus goes out of sync a threshold number of times, the request should expire after the apparatus enters idle more than a threshold number of times, and/or an indication that the apparatus request should resume if a particular LC ID resumes.

In some embodiments, apparatus 20 may be controlled by memory 34 and processor 32 to request that the network node provide a recurring series of congestion indications. At least one of the congestion indications may include policies that control at what point the network node will presume that the UE no longer prefers that the network node provide said congestion indications. According to an embodiment, the request for the recurring series of congestion indications causes the series of congestion indications to be provided at a first rate during a first time interval, and then to be provided at a second rate at a second time interval. In certain embodiments, the request for the recurring series of congestion indications causes a rate of congestion updates to be linked to the current discontinuous reception (DRX) setting, where the congestion updates do not reset the short/long DRX state, and the congestion updates are provided more frequently during short DRX and less frequently during the long DRX. According to an embodiment, the request may further include the UE indicating specific conditions that will result in the periodicity of the recurring congestion indications changing.

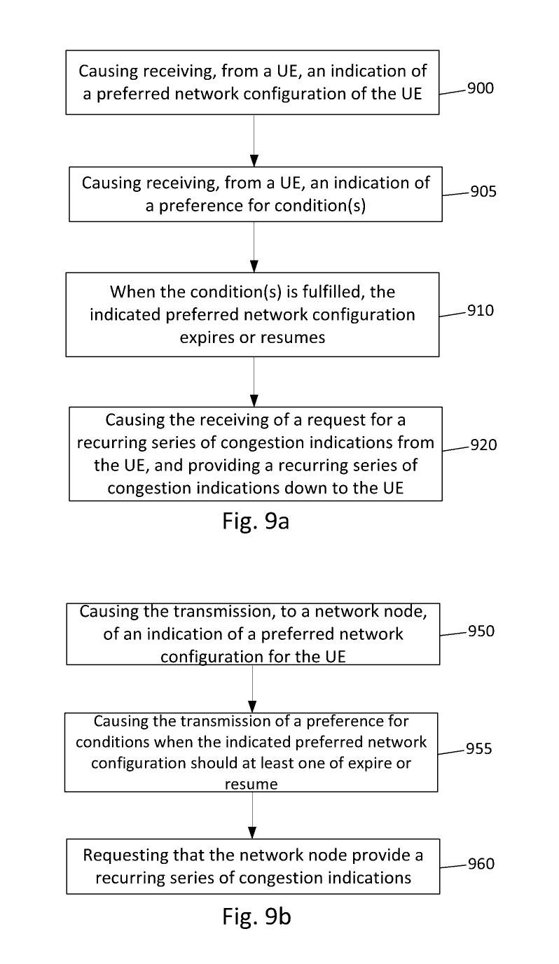

FIG. 9a illustrates an example flow diagram of a method, according to one embodiment of the invention. In certain embodiments, the method of FIG. 9a may be performed by a network node, such as a base station or eNB. As illustrated in FIG. 9a, the method may include, at 900, causing the receiving, from a UE, of an indication of a preferred network configuration of the UE. The method may further include, at 905, causing the receiving of an indication of a preference for one or more conditions when the indicated preferred network configuration should automatically expire and/or resume. For example, the condition(s) may indicate at which point the UE prefers that the network stops using the parameter value previously preferred/indicated by the UE. The method may also include, at 910, when the condition(s) is fulfilled, the indicated preferred network configuration may expire or resume.

According to one embodiment, the UE indicated network configuration may include a quick idle request, an extended RRC connection request or inactivity timer value, an updated connected DRX request, and/or a request for recurring series of congestion indications to the UE.

In an embodiment, the UE indication of a preference for the conditions under which (if/when) the UE indicated preference should (automatically) expire or resume may include an indication that at least one of: UE request should preferably expire after a first time interval, the UE request should expire after at least a threshold number of additional bytes are transferred (e.g., while the UE is still RRC connected), the UE request should expire after a new traffic LCID/flow begins, the UE request should expire after a previously existing traffic LCID/flow stops (e.g., according to some further criteria defining “stops”), the UE request should expire after the preference is “utilized” a threshold number of times, the UE request should expire after the UE goes out of sync a threshold number of times, the UE request should expire after the UE enters idle more than a threshold number of times, and/or an indication that the UE preference request should resume if a particular LC ID resumes, (or after one of the other policies mentioned).

The method may also include, at 920, causing the receiving, from the UE, of a request for a recurring series of congestion indications, and providing a recurring series of congestion indications down to the UE. At least one of the indications may include policies that control at what point the eNB can presume that the UE no longer prefers that the network provide such updates. In one embodiment, the UE congestion update request service to cause series of congestion updates may be provided at a first rate during a first time interval, and then be provided at a second rate at a second time interval. The congestion update request may cause the rate of updates to be linked to the current DRX setting, where congestion updates do not reset the short/long DRX state, and the congestion updates are provided more frequently during shortDRX and less frequently during the long DRx.

Furthermore, in some embodiments, the method may include receiving, from the UE, a range of policies that further indicate specific conditions which will result in the periodicity of the recurring updates changing. For instance, the congestion updates should be provided periodically at a first rate, until a particular LC ID stops, after which they should be provided at a second rate. In an embodiment, the congestion updates should be provided periodically at a first rate, until a particular (new) LC ID starts, after which they should be provided at a second rate.

FIG. 9b illustrates an example flow diagram of a method, according to another embodiment of the invention. In certain embodiments, the method of FIG. 9b may be performed by a device, such as a UE in LTE or LTE-A. As illustrated in FIG. 9b, the method may include, at 950, causing a transmission to a network node (e.g., eNB) an indication of a preferred network configuration for the UE. The method may also include, at 955, causing a transmission of a preference for conditions when the indicated UE preferred network configuration should at least one of expire or resume. In certain embodiments, the conditions may be sent in the same transmission as the preferred network configuration; while in other embodiments, the conditions may be sent in a separate transmission from the preferred network configuration.

In one embodiment, the indication of the UE preferred network configuration may include a quick idle request, an extended radio resource control (RRC) connection request or inactivity timer value, an updated connected discontinuous reception (DRX) request, and/or a request for recurring series of congestion indications to the apparatus.

According to an embodiment, the preference for the conditions may comprise at least one of: a request should preferably expire after a first time interval, the request should expire after at least a threshold number of additional bytes are transferred, the request should expire after a new traffic logical channel identifier (LCID)/flow begins, the request should expire after a previously existing traffic LCID/flow stops, the request should expire after the preference is fulfilled and/or utilized a threshold number of times, the request should expire after the apparatus goes out of sync a threshold number of times, the request should expire after the apparatus enters idle more than a threshold number of times, and/or an indication that the apparatus request should resume if a particular LC ID resumes.

In some embodiments, the method may also include, at 960, requesting that the network node provide a recurring series of congestion indications. At least one of the congestion indications may include policies that control at what point the network node will presume that the UE no longer prefers that the network node provide the congestion indications. According to an embodiment, the request for the recurring series of congestion indications causes the series of congestion indications to be provided at a first rate during a first time interval, and then to be provided at a second rate at a second time interval. In certain embodiments, the request for the recurring series of congestion indications causes a rate of congestion updates to be linked to the current discontinuous reception (DRX) setting, where the congestion updates do not reset the short/long DRX state, and the congestion updates are provided more frequently during short DRX and less frequently during the long DRX. According to an embodiment, the request may further include the UE indicating specific conditions that will result in the periodicity of the recurring congestion indications changing.

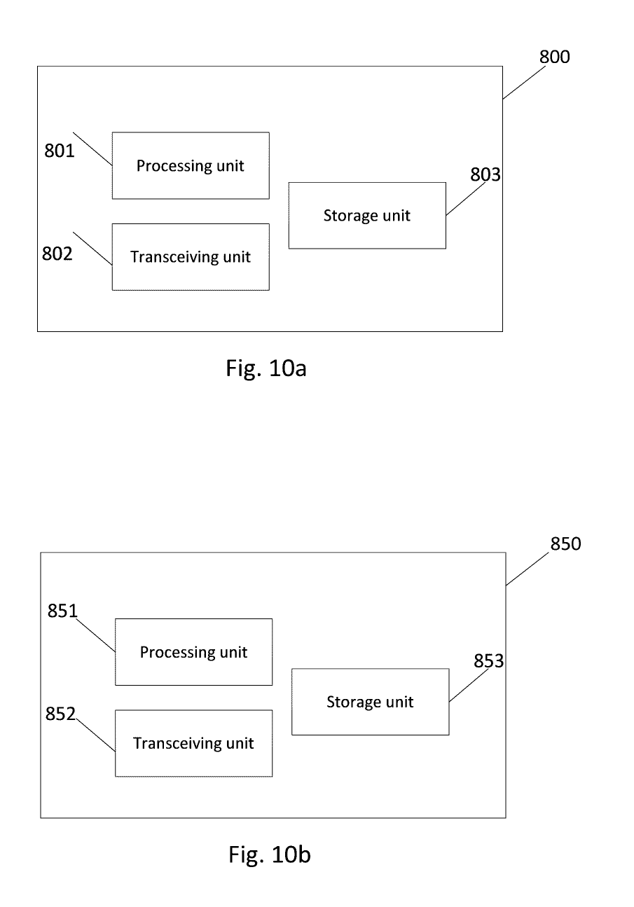

FIG. 10a illustrates a block diagram of an apparatus 800, according to one embodiment. As illustrated in the example of FIG. 10a, apparatus 800 may include a processing unit or means 801 for controlling apparatus 800 and for carrying out instructions of a computer program, for example, by performing arithmetic, logical, control and input/output (I/O) operations specified by the instructions. Apparatus 800 may also include a storage unit or means 803 for storing information including, but not limited to, computer program instructions or software modules that provide functionality when executed by processing unit 801. Apparatus 800 may further include a transceiving unit or means 802 for receiving or transmitting information. In an embodiment, transceiving unit or means 802 may cause the receiving, from a UE, of an indication of a preferred network configuration of the UE. According to an embodiment, transceiving unit or means 802 may cause the receiving of an indication of a preference for one or more conditions when the indicated preferred network configuration should automatically expire and/or resume. For example, the condition(s) may indicate at which point the UE prefers that the network stops using the parameter value previously preferred/indicated by the UE. When the condition(s) is fulfilled, the indicated preferred network configuration may expire or resume. In one embodiment, transceiving unit or means 802 may cause the receiving, from the UE, of a request for a recurring series of congestion indications, and the providing of a recurring series of congestion indications down to the UE. Furthermore, in some embodiments, transceiving unit or means 802 may cause the receiving, from the UE, a range of policies that further indicate specific conditions which will result in the periodicity of the recurring updates changing.

FIG. 10b illustrates a block diagram of an apparatus 850, according to one embodiment. As illustrated in the example of FIG. 10b, apparatus 850 may include a processing unit or means 851 for controlling apparatus 850 and for carrying out instructions of a computer program, for example, by performing arithmetic, logical, control and input/output (I/O) operations specified by the instructions. Apparatus 850 may also include a storage unit or means 853 for storing information including, but not limited to, computer program instructions or software modules that provide functionality when executed by processing unit 851. Apparatus 850 may further include a transceiving unit or means 852 for receiving or transmitting information. In an embodiment, transceiving unit or means 852 may cause a transmission to a network node (e.g., eNB) an indication of a preferred network configuration for the UE. The transceiving unit or means 852 may further cause a transmission of an indication of a preference for conditions when the indicated UE preferred network configuration should at least one of expire or resume.

In some embodiments, transceiving unit or means 852 may also cause the requesting that the network node provide a recurring series of congestion indications. At least one of the congestion indications may include policies that control at what point the network node will presume that the UE no longer prefers that the network node provide the congestion indications. According to an embodiment, the request for the recurring series of congestion indications causes the series of congestion indications to be provided at a first rate during a first time interval, and then to be provided at a second rate at a second time interval. In certain embodiments, the request for the recurring series of congestion indications causes a rate of congestion updates to be linked to the current discontinuous reception (DRX) setting, where the congestion updates do not reset the short/long DRX state, and the congestion updates are provided more frequently during short DRX and less frequently during the long DRX. According to an embodiment, the request may further include the UE indicating specific conditions that will result in the periodicity of the recurring congestion indications changing.

Embodiments of the invention may provide several advantages and/or technical improvements. For example, certain embodiments are able to avoid inefficiencies by sharing knowledge/preferences between UE/Apps and the network node (e.g., eNB). For instance, eNB inactivity and RRC connected DRX configuration decisions may use knowledge of UE traffic preferences, and UE decisions can use eNB knowledge of congestion. This sharing enables a host of benefits, such as improving battery life and capacity, avoiding excess UE connected/modem-on time and excess RRC transitions, and creating numerous additional improvements from “joint” decision-making. Some embodiments may define a protocol for this knowledge sharing, which may include “radio level” messaging, such as MAC and RRC messaging. The knowledge sharing protocol may use one or more of the reserved indexes within the MAC CE message on the uplink and/or downlink. When the UE determines that it can use the knowledge sharing protocol, it may transmit uplink knowledge sharing messaging to the network/eNB, and it can do this over a MAC (media access control) message, known as a communication element within the 3GPP standard. This uses one of the currently unused (or reserved) indexes.

According to embodiments, programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality of any method or apparatus described herein may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that may be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
causing, by a user equipment, a transmission to a network node of an indication of a preferred network configuration; and
causing a transmission of an indication of a preference for at least one condition when the indicated preference of the preferred network configuration should at least one of expire or resume.

2. The method according to claim 1, wherein the indicated preferred network configuration comprises at least one of:
a quick idle request;
a request to extend a radio resource control connection or inactivity timer value;
a request for an updated connected discontinuous reception configuration; or
a request for recurring series of congestion indications to the user equipment.

3. The method according to claim 1, wherein the indication of a preference for the at least one condition comprises at least one of:
a user equipment request should preferably expire after a first time interval;
the user equipment request should expire after at least a threshold number of additional bytes are transferred;
the user equipment request should expire after a new traffic logical channel identifier/flow begins;
the user equipment request should expire after a previously existing traffic logical channel identifier/flow stops;
the user equipment request should expire after the preference is fulfilled a threshold number of times;
the user equipment request should expire after the UE goes out of sync a threshold number of times;
the user equipment request should expire after the UE enters idle more than a threshold number of times; or
an indication that the user equipment request should resume if a particular logical channel identifier resumes.

4. The method according to claim 1, further comprising requesting that the network node provide a recurring series of congestion indications to the user equipment.

5. The method according to claim 4, wherein at least one of the congestion indications comprises policies that control at what point the network node will presume that the user equipment no longer prefers that the network node provide said congestion indications.

6. The method according to claim 4, wherein said requesting for the recurring series of congestion indications causes the series of congestion indications to be provided at a first rate during a first time interval, and then to be provided at a second rate at a second time interval.

7. The method according to claim 4, wherein said requesting for the recurring series of congestion indications causes a rate of congestion updates to be linked to the current discontinuous reception setting, wherein the congestion updates do not reset the short/long discontinuous reception state, and the congestion updates are provided more frequently during short discontinuous reception and less frequently during the long discontinuous reception.

8. The method according to claim 4, wherein the requesting further comprises the user equipment indicating specific conditions that will result in the periodicity of the recurring congestion indications changing.

9. An apparatus, comprising:
at least one processor; and
at least one memory comprising computer program code,
the at least one memory and the computer program code are configured, with the at least one processor, to cause the apparatus at least to
transmit to a network node an indication of a preferred network configuration; and
transmit an indication of a preference for at least one condition when the indicated preference of the preferred network configuration should at least one of expire or resume.

10. The apparatus according to claim 9, wherein the indication of the preferred network configuration comprises at least one of:
a quick idle request;
a request to extend a radio resource control connection or inactivity timer value;
a request for an updated connected discontinuous reception configuration; or
a request for recurring series of congestion indications to the apparatus.

11. The apparatus according to claim 9, wherein the indication of a preference for the at least one condition comprises at least one of:
a request should preferably expire after a first time interval;
the request should expire after at least a threshold number of additional bytes are transferred;
the request should expire after a new traffic logical channel identifier/flow begins;
the request should expire after a previously existing traffic logical channel identifier/flow stops;
the request should expire after the preference is fulfilled a threshold number of times;
the request should expire after the apparatus goes out of sync a threshold number of times;
the request should expire after the apparatus enters idle more than a threshold number of times; or
an indication that the apparatus request should resume if a particular logical channel identifier resumes.

12. The apparatus according to claim 9, wherein the at least one memory and the computer program code are further configured, with the at least one processor, to cause the apparatus at least to request that the network node provide a recurring series of congestion indications.

13. The apparatus according to claim 9, wherein the apparatus comprises a user equipment.

14. An apparatus, comprising:
at least one processor; and
at least one memory comprising computer program code,
the at least one memory and the computer program code are configured, with the at least one processor, to cause the apparatus at least to
receive, from a user equipment, an indication of a preferred network configuration of the user equipment;
receive an indication of a preference for at least one condition when the indicated preferred network configuration should at least one of expire or resume; and
when the at least one condition is fulfilled, the indicated preferred network configuration expires or resumes.

15. The apparatus according to claim 14, wherein the indicated preferred network configuration comprises at least one of:
a quick idle request;
a request to extend a radio resource control connection or inactivity timer value;
a request for an updated connected discontinuous reception configuration; or
a request for recurring series of congestion indications to the user equipment.

16. The apparatus according to claim 14, wherein the indication of a preference for the at least one condition comprises at least one of:
a user equipment request should preferably expire after a first time interval;
the user equipment request should expire after at least a threshold number of additional bytes are transferred;
the user equipment request should expire after a new traffic logical channel identifier/flow begins;
the user equipment request should expire after a previously existing traffic logical channel identifier/flow stops;
the user equipment request should expire after the preference is fulfilled a threshold number of times;
the user equipment request should expire after the UE goes out of sync a threshold number of times;
the user equipment request should expire after the UE enters idle more than a threshold number of times; or
an indication that the user equipment request should resume if a particular logical channel identifier resumes.

17. The apparatus according to claim 14, further comprising:
receiving a request to provide a recurring series of congestion indications; and
providing the requested recurring series of congestion indications to the user equipment.

18. The apparatus according to claim 17, wherein at least one of the congestion indications comprises policies that control at what point the apparatus will presume that the user equipment no longer prefers that the apparatus provide said congestion indications.

19. The apparatus according to claim 17, wherein said requesting for the recurring series of congestion indications causes the series of congestion indications to be provided at a first rate during a first time interval, and then to be provided at a second rate at a second time interval.

20. The apparatus according to claim 14, wherein the apparatus comprises an evolved node B.
